(19) United States
(12) Patent Application Publication
(10) Pub. No.: US 2006/0119066 A1
(43) Pub. Date: Jun. 8, 2006

(54) Pump

(76) Inventor: Louis Chuang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/999,301

(22) Filed: Nov. 29, 2004

(51) Int. Cl. B62J 11/02; F04B 53/10

(52) U.S. Cl. 280/201; 417/559

(57) ABSTRACT

A pump is disclosed for a bicycle. The pump includes a cylinder, a piston, a rod and a handle. The piston is movably put in the cylinder. The rod is connected with the piston. The handle is connected with the rod. The handle can be locked to the cylinder so that the pump can be used instead of a broken cushion of the bicycle.

### BACKGROUND OF INVENTION

1. Field of Invention The present invention relates to a pump that can be used instead of a broken cushion of a bicycle.

2. Related Prior Art

Referring to FIG. 9, a conventional pump includes a cylinder 100, a nozzle 110, a rod 120, a handle 140, and a pressure gauge 200. The cylinder 100 is connected with the nozzle 110. The rod 120 includes an end connected with a piston (not shown) movably put in the cylinder 100 and another end connected with the handle 140. On the cylinder 100 is formed a connector 150 for receiving a pressure gauge 200. The nozzle 110 can be engaged with a valve. This conventional pump is nothing but a pump.

The present invention is therefore intended to obviate or at least alleviate the problems encountered in prior art.

### SUMMARY OF INVENTION

A pump is disclosed for a bicycle. The pump includes a cylinder, a piston, a rod and a handle. The piston is movably put in the cylinder. The rod is connected with the piston. The handle is connected with the rod. The handle can be locked to the cylinder so that the pump can be used instead of a broken cushion of the bicycle.

The primary advantage of the pump of the present invention is that it can be used instead of a broken cushion of the bicycle.

Other objects, advantages, and novel features of the invention will become more apparent from the following detailed description when taken in conjunction with the drawings.

### BRIEF DESCRIPTION OF DRAWINGS

The present invention will be described through detailed illustration of embodiments referring to the drawings.

FIG. 1 is a perspective view of a pump according to a first embodiment of the present invention.

FIG. 2 is a cross-sectional partial view of the pump shown in FIG. 1.

FIG. 3 is similar to FIG. 2 but shows the pump in an unlocked mode.

FIG. 4 is a perspective view of the pump for use with a bicycle and shows a cushion installed between a first link and a second link.

FIG. 5 is similar to FIG. 4 but shows that the first link cannot be supported by means of the cushion of FIG. 4.

FIG. 6 is similar to FIG. 3 but shows the pump in a locked mode.

FIG. 7 is similar to FIG. 4 but shows the pump used instead of the cushion.

FIG. 8 is a perspective view of a pump according to a second embodiment of the present invention.

FIG. 9 is a perspective view of a conventional pump.

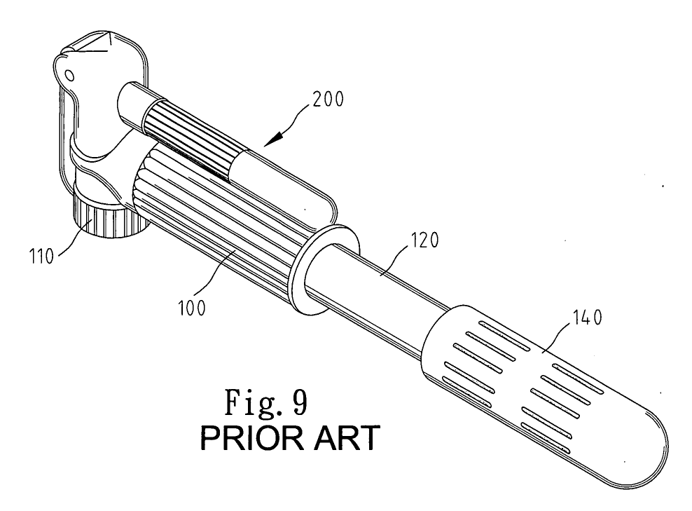

### DETAILED DESCRIPTION OF EMBODIMENTS

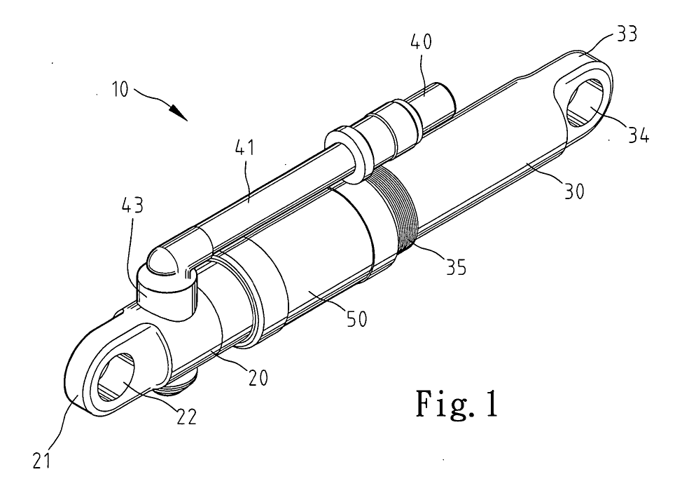

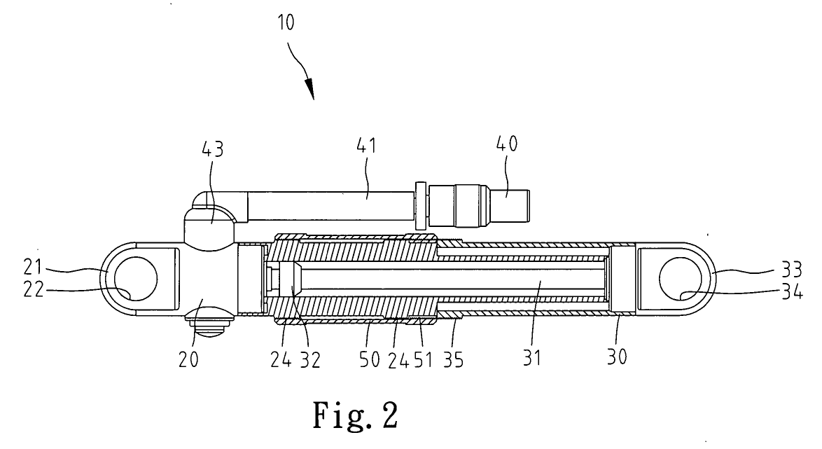

Referring to FIGS. 1 and 2, according to a first embodiment of the present invention, a pump 10 includes a cylinder 20, a handle 30, a nozzle 40 and a sleeve 50.

The cylinder 20 includes an ear 21 formed at an end thereof. The ear 21 includes an aperture 22 defined therein. Two threads 24 are formed on the cylinder 20.

The handle 30 includes an ear 33 formed at an end thereof and a thread 35 formed an opposite end thereof. The ear 33 includes an aperture 34 defined therein.

The sleeve 50 is engaged with the cylinder 20. Two threads 51 are formed on an internal face of the sleeve 50.

The pipe 41 includes a joint 43 formed at an end thereof and a nozzle 40 formed at another end thereof. The joint 43 is pivotally connected with the cylinder 20. The pipe 41 is made of a flexible material so that it can adapt to various direction when it is used to pump.

A piston 32 is movably put in the cylinder 20. The rod 31 includes an end connected with the piston 32 and another end connected with the handle 30.

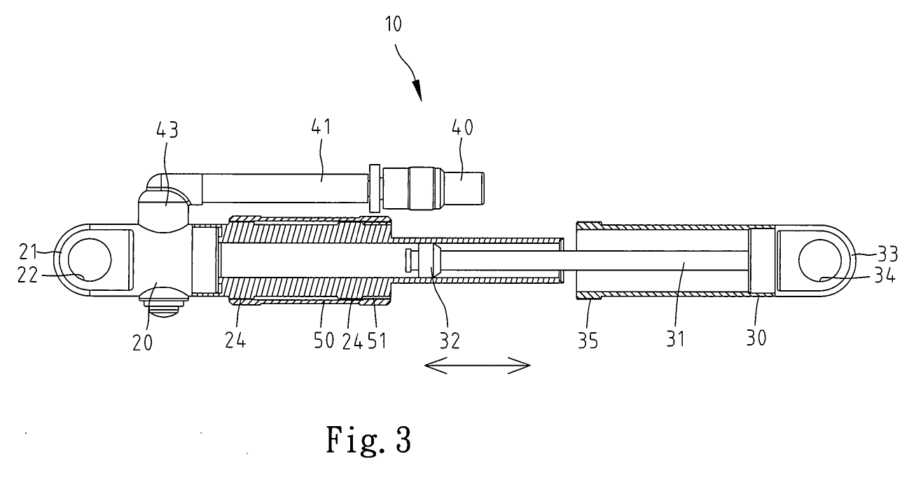

Referring to FIG. 3, the pump 10 is in an unlocked mode. The handle 30 is disengaged from the cylinder 20 so that the handle 30 can be reciprocated relative to the cylinder 20 by means of the piston 32 and the rod 31.

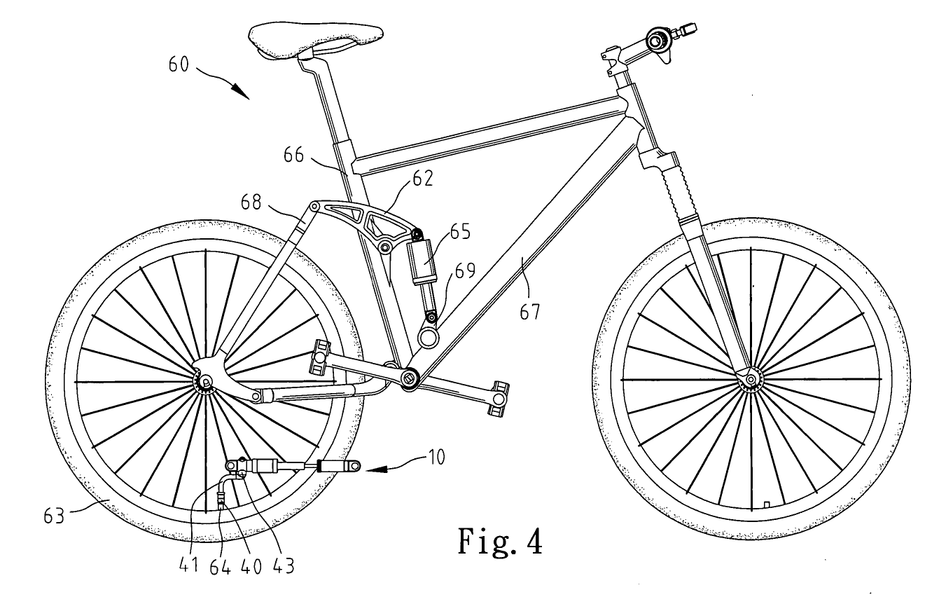

FIG. 4 shows the pump 10 for use with a bicycle 60. The nozzle 40 of the pipe 41 is engaged with a valve 64 of a tire 63 so that pressurized air flows from the pump 10 to the tire 63 through the pipe 41. The bicycle 60 includes a first link 62 pivotally mounted on a seat tube 66 and a second link 69 installed on a down tube 67. The first link 62 includes an end pivotally connected with a stay 68 and another end pivotally connected with a cushion 65. The second link 69 includes an end connected with the cushion 65. The cushion 65 can be used in normal condition when it supports the first link 62.

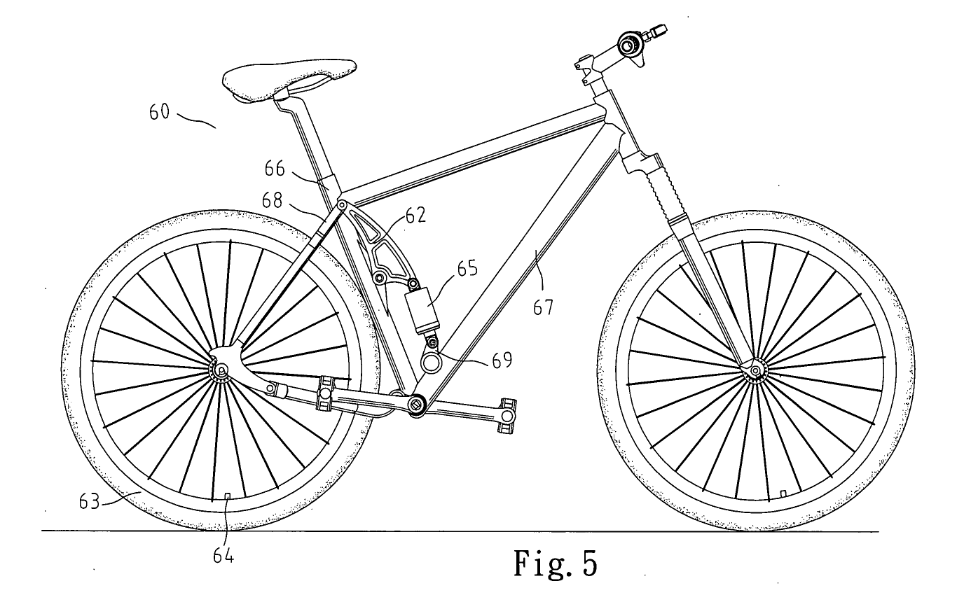

Referring to FIG. 5, when the cushion 65 fails, the first link 62 collides with the seat tube 66 because the cushion 65 cannot support the first link 62. Accordingly, it is a risky situation because friction occurs between the tire 63 and the seat tube 66.

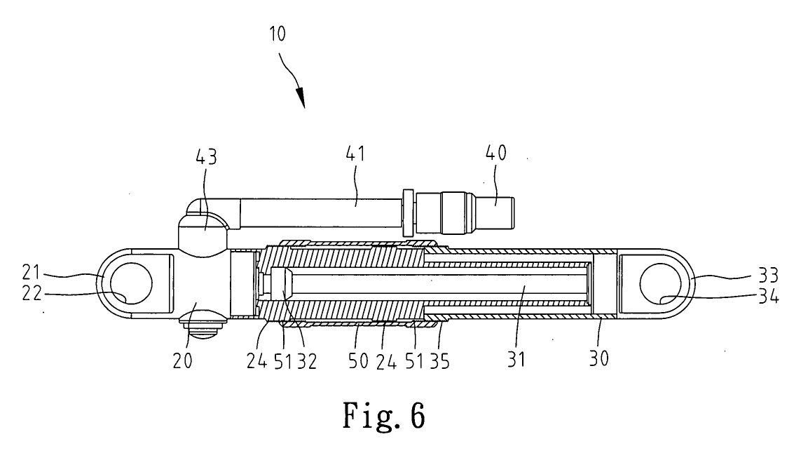

Referring to FIG. 6, the pump 10 is in a locked mode. One of the threads 51 of the sleeve 50 is engaged with the thread 35 of the handle 30. The other one of the threads 51 of the sleeve 50 is engaged with the thread 24 of the cylinder 20. Thus, the cylinder 20 is firmly connected with the handle 30 by means of the sleeve 50.

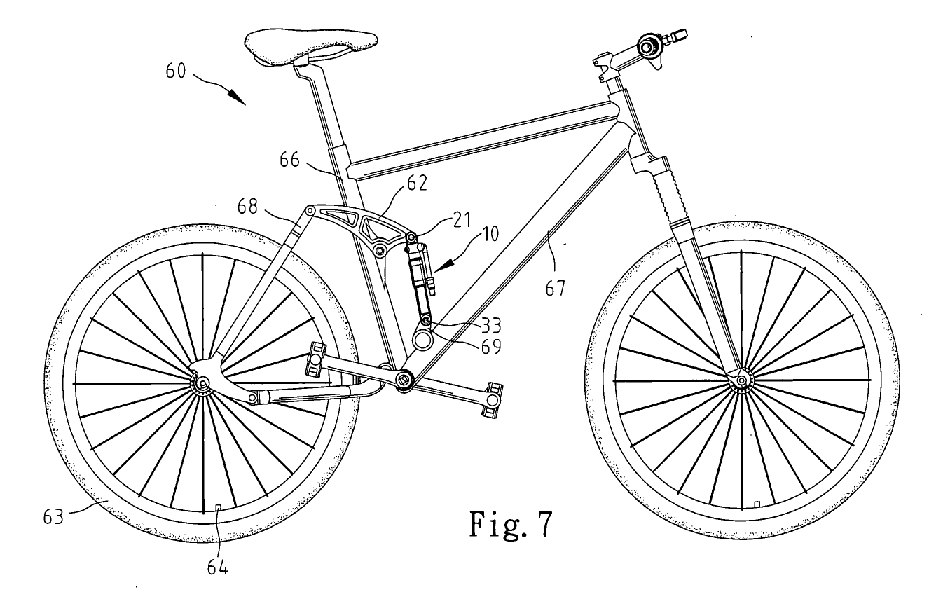

FIG. 7 shows the pump 10 used instead of the cushion 65. The pump 10 includes the ear 21 pivotally connected with the first link 62 by means of a fastener through the aperture 22 (not shown) and the ear 33 connected with the second link 63 by means of a fastener through the aperture 34 (not shown).

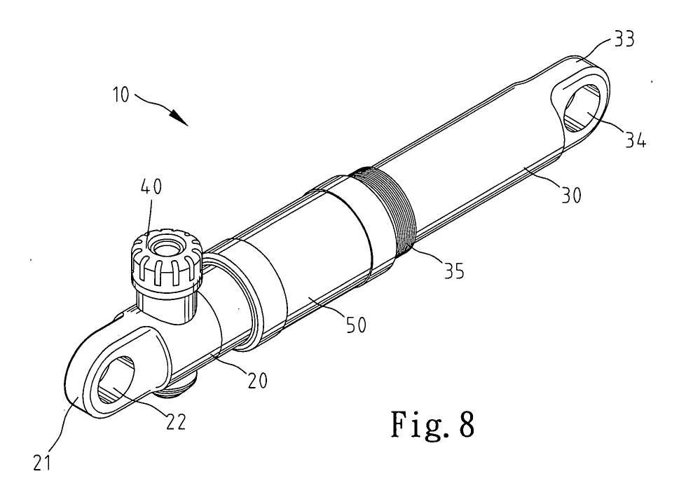

FIG. 8 shows a pump 10 according to a second embodiment of the present invention. The second embodiment is identical to the first embodiment except that the nozzle 40 is directly installed on the cylinder 20 instead of through the pipe 41.

The present invention has been described through detailed illustration of the embodiments. Those skilled in the art can derive variations from the embodiments. The embodiments hence shall not limit the scope of the present invention defined in the claims.

What is claimed is:

1. A pump comprising a cylinder, a piston movably put in the cylinder, a rod connected with the piston and a handle connected with the rod, wherein the handle can be locked to the cylinder so that the pump can be used instead of a broken cushion of a bicycle.

2. The pump according to claim 1 comprising a locking device for connecting the cylinder with the handle.

3. The pump according to claim 2 wherein the locking device comprises a sleeve for connecting the cylinder with the handle.

4. The pump according to claim 3 wherein the sleeve comprises at least one thread formed on an internal face thereof, wherein the cylinder comprises at least one thread formed on an external face thereof for engagement with the thread of the sleeve.

5. The pump according to claim 4 wherein the sleeve comprises two threads formed on an internal face thereof, wherein the handle comprises a thread formed on an external face thereof so that one of the threads of the sleeve is engaged with the thread of the handle and the other one of the threads of the sleeve engaged with the thread of the cylinder.

6. The pump according to claim 1 wherein the cylinder comprises an ear formed thereon.

7. The pump according to claim 6 wherein the ear defines an aperture for receiving a fastener.

8. The pump according to claim 1 wherein the handle comprises an ear formed thereon.

9. The pump according to claim 8 wherein the ear defines an aperture for receiving a fastener.

10. The pump according to claim 1 comprising a nozzle connected with the cylinder.

11. The pump according to claim 10 comprising a pipe for connecting the nozzle with the cylinder.

12. The pump according to claim 11 comprising a joint for connecting the pipe with the cylinder.

13. The pump according to claim 12 wherein the nozzle pivotally connects the pipe with the cylinder.
